(19) United States
(12) Patent Application Publication
(10) Pub. No.: US 2022/0267017 A1
(43) Pub. Date: Aug. 25, 2022

(54) BATTERY AIRCRAFT INTEGRATION

(71) Applicant: Lilium eAircraft GmbH, Wessling (DE)

(72) Inventors: Ryan PITRE, Wessling (DE); Angel PLAZA, Wessling (DE); Joerg WEBER, Wessling (DE); Axel DIETRICH, Gilching (DE); Gerd FRITSCH, Wessling (DE); Jason DUNTHORN, Wessling (DE); Felix SCHEILE, Wessling (DE); Armin ADER, Wessling (DE)

(21) Appl. No.: 17/673,962

(22) Filed: Feb. 17, 2022

(30) Foreign Application Priority Data
Feb. 19, 2021 (EP) 21158226.7

(51) Int. Cl. B64D 27/24; B64C 29/00; B60L 50/60; B60L 50/64

(52) U.S. Cl. CPC B64D 27/24; B64C 29/0033; B60L 50/66; B60L 50/64; B64D 2221/00; B60L 2200/10

(57) ABSTRACT

The present invention relates to an aircraft, comprising a fuselage, at least one pair of wings and a battery system for providing power to electrical systems of the aircraft, wherein the battery system comprises at least one battery pack, each battery pack comprises a number of individual battery modules, which are directly or indirectly coupled to one another, and the at least one battery pack is disposed between an inner structural wall defining an interior space of the fuselage and an outer fairing wall of the fuselage. The fuselage is provided with a rack mounting mechanism comprising a number of mounting brackets, each for exchangeably mounting one of the battery modules to the aircraft, and each of the battery packs is a virtual battery pack, which is obtained by electrically connecting a predetermined number of the battery modules.

The present invention relates to an aircraft, comprising a fuselage, at least one pair of wings and a battery system for providing power to electrical systems of the aircraft, wherein the battery system comprises at least one battery pack, an wherein each battery pack comprises a number of individual battery modules, which are directly or indirectly coupled to one another.

Generally, battery packs are composed of a number of battery modules, which in turn consists of a plurality of battery cells. If battery systems are included in an aircraft, e.g. to provide power, battery packs must contain certain features, in order to protect the battery cells and/or modules from the operating environment and the passengers from battery cells and/or modules in failure scenarios. These features reduce the effective energy density of the system by nature of extra “non-useful mass”. However, this extra mass should be reduced.

Traditional aerospace has not used battery systems for propulsive power supply, hence, prior art with respect to this topic is rare. However, WO 2019/232472 A1, which discloses an electric vertical take-off and landing (EVTOL) aircraft, suggests a system of six distributed battery packs, each pack being an enclosed structure with multiple battery modules within each enclosed pack structure. In WO 2019/232472 A1, the battery packs are arranged beneath the passenger compartment/cockpit, but mainly in the wings of the aircraft. Such arrangement leads to the problem of quite thick wings having a relatively large vertical dimension in a wing cross section, which may negatively influence aerodynamics of the aircraft.

In prior art of the distantly related field of automotive battery systems the topic of battery arrangement is typically solved by packaging all battery modules centrally into a common structural enclosure (the term “skateboard” is often used) underneath the vehicle.

However, grouping of battery modules into a pack is a redundant structural strategy, where multiple enclosures lead to higher mass. Moreover, the tight packing of battery modules makes preventing propagation of thermal runaway between modules difficult, requiring additional mass.

Furthermore, from a maintenance point of view, when a single battery module is faulty, replacement would be quite an expensive process, as the battery pack would need to be extracted and opened up, the battery module would need to be replaced, and the battery pack would need to be re-closed and reinstalled. The battery pack itself would be too heavy for an operator to handle, such that special equipment would be required. Additionally, battery arrangement below passengers as well as within wings is disadvantageous in case of battery failure leading to fire, since passengers may be exposed to danger and the locations below the passenger compartment or the cockpit and within the wings are not easy to reach. This fact also entails maintenance disadvantages, e.g. when replacing batteries.

In view of this background, it was an object of the present invention to overcome the problems of the prior art and to provide an aircraft with a battery system as light weight as possible, while also having sufficient safety, performance and maintainability capabilities.

According to a first aspect of the present invention, this object is achieved by an aircraft, comprising a fuselage, at least one pair of wings and a battery system for providing power to electrical systems of the aircraft, wherein the battery system comprises at least one battery pack, each battery pack comprises a number of individual battery modules, which are directly or indirectly coupled to one another, and the at least one battery pack is disposed between an inner structural wall defining an interior space of the fuselage and an outer fairing wall of the fuselage.

Such arrangement is maintainable because the at least one battery pack is accessible from outside, since only the aircraft outer wall is present between an operator and the at least one battery pack. Therefore, it can easily be exchanged without massive equipment. A better maintainability of the system leads to a lower vehicle down time. In particular, the interior space of the fuselage may be a passenger compartment and/or a luggage compartment and/or a cockpit of the aircraft.

Throughout the entire disclosure of the present invention, a battery cell refers to a smallest packaged form a battery can take. A cell is suitable for storing energy and comprises at least two terminals in form of positive and negative electrodes. A battery module consists of several cells generally connected in either series or parallel in a module structure such as a housing or another enclosure. Typically, a cell stack is enclosed in a housing. A battery pack is assembled by connecting modules together in a pack structure such as a frame or housing and typically constitutes a closed unit or structure.

In a preferred embodiment of the present invention, the fuselage may comprise the outer fairing wall enclosing the fuselage and the interior space formed within the fuselage, wherein the interior space may be defined by, at a bottom portion thereof, a bottom plate at which a plurality of aircraft seats are mounted, the bottom plate limiting the interior space of the fuselage downwards and defining a bottom plane substantially parallel to a wing plane of the aircraft, and, at side and upper portions thereof, the inner structural wall limiting the interior space of the fuselage laterally and upwards, wherein the at least one battery pack, in a direction orthogonal to the bottom plane, is at least partially, preferably completely, disposed at a height above the bottom plate. Hence, maintainability of the aircraft, in particular with respect to its battery system can be further improved, since the at least one battery pack is easily accessible from outside through openings only in the aircraft outer wall or the like. Moreover, the at least one battery pack is disposed at a height level in a vertical direction over the ground, which is comfortably reachable by an operator, when changing or maintaining the battery packs. Therefore, it can easily be exchanged without massive equipment and better maintainability of the system in turn leads to lower aircraft down time.

Preferably, the battery system may comprise at least two battery packs, and, with respect to a longitudinal axis of the aircraft, on either side of the fuselage, at least one of the battery packs may be disposed between the inner structural wall of the fuselage and the outer fairing wall of the fuselage. Arranging battery packs on either side of the fuselage allows for an even distribution, in particular with respect to a center of gravity of the aircraft.

In a beneficial embodiment of the present invention, the battery system may comprise a plurality of battery packs, said plurality of battery packs being divided into two groups of battery packs, and, with respect to a longitudinal axis of the aircraft, on either side of the fuselage, one of the two groups of battery packs may be disposed between the inner structural wall of the fuselage and the outer fairing wall of the fuselage. Such arrangement allows for an even distribution with respect to a center of gravity of the aircraft. Moreover, dividing the battery packs in two groups leads to less system complexity compared to an arrangement underneath a passenger compartment and additionally within the wings of an aircraft. For example, cable length of cables connecting the battery modules and/or battery packs can be reduced, since the battery packs are disposed close to each other in two groups, one on either side of the fuselage, between the inner structural wall and the outer fairing wall of the fuselage. Thus, fewer parts have to be produced leading to lower cost of the overall system.

According to a second aspect of the present invention, the above-cited object is achieved by an aircraft, in particular according to the first aspect, comprising a fuselage, at least one pair of wings and a battery system for providing power to electrical systems of the aircraft, wherein the battery system comprises at least one battery pack, each battery pack comprises a number of individual battery modules, which are directly or indirectly coupled to one another, and the fuselage is provided with a rack mounting mechanism comprising a number of mounting brackets, each for exchangeably mounting one of the battery modules to the aircraft.

Typically, battery modules are enclosed in a pack level structure, which is in turn mounted to the aircraft. Such battery packs are quite large and heavy and therefore difficult to handle, when they have to be maintained or exchanged. However, the arrangement according to the second aspect of the present invention is a “quick-replace” solution for individual battery modules. This allows the aircraft to spend more time operating and less time for maintenance. Additionally, the discretization of the system into smaller modules allows for a single operator to handle/install/remove battery modules without specialized lifting equipment. The resulting system is lightweight due to not having nested structures. It is a high performance system due to the cell selection and low weight. It is safe because failures are contained to single modules and do not propagate through the system. It is maintainable because single battery modules can be exchanged without massive equipment. The discretization of the pack into single modules/units also allows for more conformity to the aircraft surface, which allows better utilization of available volume. This reduces the aircraft cross-section, reducing drag and improving performance. Overall, better maintainability of the system leads to lower vehicle down time. The rack mounting mechanism may be any mechanism suitable for exchangeably mounting a battery module to the aircraft. In this context, “exchangeably mounting”, means that a battery module can individually be removed from the aircraft and then reinstalled or replaced by another, in particular similar or identical, battery module.

In a preferred embodiment of the present invention, the battery system may further comprise a thermal management system circulating a heat transfer fluid through the battery modules, wherein at least one, preferably all, of the battery modules may comprise at least one hollow bolt constituting an inlet to or an outlet from an internal channel system of the corresponding battery module for heat transfer fluid within the corresponding battery module via an internal channel of the hollow bolt, wherein the thermal management system may comprise at least one hollow stud configured to supply or receive the heat transfer fluid to or from the correspond battery module via an internal channel of the hollow stud, wherein the internal channel of the hollow stud is configured to be connected to the internal channel of the hollow bolt, and wherein the internal channel of the hollow stud comprises a first channel portion substantially extending in a direction of extension of the hollow stud and a second channel portion adjacent to the first channel portion and extending in a direction different from the direction of extension of the hollow stud, preferably in a direction inclined at approximately 90° with respect to the direction of extension of the hollow stud and/or parallel to the direction of extension of the hollow bolt, and/or wherein the internal channel of the hollow bolt comprises a first channel portion substantially extending in a direction of extension of the hollow bolt and a second channel portion adjacent to the first channel portion and extending in a direction different from the direction of extension of the hollow bolt, preferably in a direction inclined at approximately 90° with respect to the direction of extension of the hollow bolt and/or parallel to the direction of extension of the hollow stud. Hence, on the side of the fuselage, there is provided the hollow stud, in which already a rotation or deflection of the fluid towards the battery module may be performed. Due to this geometry, the internal channel of the hollow stud may be lined up with the internal channel of the hollow bolt on the side of the battery module. This arrangement presents a very lightweight way of changing the fluid direction with a minimum number of parts. Alternatively, the fluid may also be deflected within the internal channel of the hollow bolts as stated above.

In particular, at least one, preferably all, of the battery modules may comprise first and second hollow bolts, each having an annular connector portion at an end portion facing away from the corresponding battery module, the first hollow bolt constituting an inlet to the internal channel system of the corresponding battery module and the second hollow bolt constituting an outlet from the internal channel system of the corresponding battery module via internal channels of the first and second hollow bolts, respectively, wherein the thermal management system may comprise first and second hollow studs, each hollow stud having an internal channel, which comprises a first channel portion substantially extending in a direction of extension of the hollow stud and a second channel portion adjacent to the first channel portion and extending towards the battery module in a direction different from the direction of extension of the hollow stud, preferably in a direction inclined at approximately 90° with respect to the direction of extension of the hollow stud, and wherein end portions of the first and second hollow studs are configured to be received in the annular connector portions of the first and second hollow bolts, respectively, such as to connect the internal channels of the first and second hollow studs to the internal channels of the first and second hollow bolts, respectively. According to this preferred arrangement, two functions can be performed. As a first function, the annular connector portions of the hollow bolts serve as a mechanical fixation of the battery modules to the fuselage by receiving the end portions of the hollow studs, which in turn supply the battery modules with cooling or heat transfer fluid from the thermal management system. Hence, as a second function, during cooling inlet and outlet connectors for the cooling fluid can be provided.

Preferably, the rack mounting mechanism may comprise at least one mounting frame associated to the fuselage, and at least one, preferably all, of the battery modules may further comprise at least one slider portion slidably engaging at least one complementary slider seating provided at the mounting frame of the rack mounting mechanism, to allow a sliding motion of the battery module along a direction of extension of the mounting frame of the rack mounting mechanism. A slider portion at the side of the battery module slidably engaging a complementary slider seating at the side of the fuselage presents an easy way for exchangeably mounting individual battery modules in a quick manner. Hence, maintenance of the aircraft can be further simplified and improved.

Furthermore, the rack mounting mechanism may comprise at least one mounting frame associated to the fuselage, and at least one, preferably all, of the battery modules may further comprise at least one blind connector configured to fix in place the at least one battery module at the rack mounting mechanism. The at least one blind connectors may preferably be realized in the form of a small pin or protrusion provided at either side of the battery module and configured to engage a complementary recess at a portion associated to the fuselage. Blind connectors, in particular together with a slider portion, present another advantageous “quick-replace” solution for exchangeably mounting the battery modules. Hence, maintenance of the aircraft can be further simplified and improved.

While the fuselage of the aircraft is provided with a rack mounting mechanism enabling an exchangeable mounting of the battery modules to the aircraft, the battery system may further comprise a thermal management system circulating a heat transfer fluid through the battery modules, at least several, preferably all battery modules, may comprise a fluid inlet connector and a fluid outlet connector connected to an internal channel system of the corresponding battery module for heat transfer fluid within the corresponding battery module and adapted to being connected to the thermal management system, and at least several, preferably all mounting brackets may comprise counterpart connectors for the fluid inlet and outlet of the corresponding battery module, respectively. Hence, the battery system may be automatically connected to the thermal management system of the aircraft, in particular using quick connections by means of the rack mounting mechanism. Thus, unnecessary structural overhead can be removed by incorporating protective measures such as cooling at the battery module level. This may lead to better thermal runaway safety.

According to a third aspect of the present invention, the above-cited object is achieved by an aircraft, in particular according to the first and/or second aspect, comprising a fuselage, at least one pair of wings and a battery system for providing power to electrical systems of the aircraft, wherein the battery system comprises at least one battery pack, each of the battery packs comprises a number of individual battery modules, which are directly or indirectly coupled to one another, and each of the battery packs is a virtual battery pack, which is obtained by electrically connecting a predetermined number of the battery modules.

In other words, according to the third aspect of the present invention, the battery modules are not enclosed in a pack level structure such as a housing etc. Hence, a distributed network of battery packs is provided, where individual battery packs are not enclosed in a structure but are instead distributed in the aircraft, in particular on both sides. A battery pack only exists virtually, i.e. by electrically connecting battery modules together. The virtual pack network removes unnecessary structural overhead by incorporating all protective measures at the battery module level. In addition, protection for failure propagation between modules is easier because they are mechanically separated. The virtual pack network is a “quick-replace” solution, for entire packs as well as for individual battery modules. This allows the aircraft to spend more time operating and less time for maintenance. Additionally, the discretization of the system into smaller modules allows for a single operator to handle/install/remove battery modules without specialized lifting equipment. The discretization of the pack into single units also allows for more conformity to the aircraft surface, which allows better utilization of available volume. This reduces the aircraft cross-section, reducing drag and improving performance. The resulting system is lightweight due to not having nested structures. It is a high performance system due to the cell selection and low weight. It is safe because failures are contained to single modules and do not propagate through the system. It is maintainable because single modules or battery packs can be exchanged without massive equipment.

According to the first, second and/or third aspect of the present invention, the battery modules of each of the battery packs may be electrically connected in series, in particular by bus bars facing towards an outside of the aircraft. Such arrangement facilitates maintenance. Moreover, the battery modules may in particular be identical or at least similar. In this case, the modules may be rotated upside down before installing such that all modules can be electrically connected in series with their terminals facing outside on either side of the aircraft. Hence, the system may be less complex, fewer parts have to be used, e.g. the cable length necessary for connecting the modules can drastically be reduced and a lightweight and more cost efficient overall system may be achieved.

In a beneficial embodiment of the present invention, each of the battery modules may be individually secured to the fuselage of the aircraft at a certain mounting position. In particular, a rack mounting mechanism with quick connects may be used.

In this case, the fuselage may be provided with a number of said mounting positions, each for interchangeably holding one of the battery modules, the number of mounting positions being larger than the number of battery modules such that, in a mounted state of all battery modules, at least one of the mounting positions remains vacant.

High-capacity battery assemblies are usually not constructed monolithically, but comprise a number of individual battery modules, which in the configuration of an aircraft according to the present invention may be positioned according to different mounting positions in the mounting assembly located within the fuselage of the aircraft in order to adjust its center of gravity. While it is usually desired to have as large a battery capacity in the aircraft as possible, since in the aircraft according to the present invention the vacant mounting positions and/or the displacement assembly hardly add any additional weight to the aircraft, the benefits of being able to adjust the center of gravity of the aircraft by means of relocating the battery modules and thus where applicable indirectly also the vacant mounting positions within the mounting assembly can be achieved without any major drawbacks and with basically almost the same mass per unit of electrical capacity of the mounting assembly and battery modules combined as compared with a smaller mounting assembly, in which no vacant mounting positions or displacement assemblies are provided.

In a preferred embodiment of the present invention, the aircraft may be of the electrical propulsion type. In aircraft of the electrical propulsion type battery mass may be approximately one third of the entire mass of the aircraft. Hence, a lightweight system as provided by the present invention is very advantageously applicable to aircraft of the electrical propulsion type.

In an even more preferred embodiment of the present invention, the aircraft may be an electric vertical take-off and landing aircraft. Since an electric vertical take-off and landing (EVTOL) aircraft is intended to operate as often as possible, the battery packs/modules will age more quickly, and will require replacement more than a typical battery electric vehicle (BEV). Additionally, the safety criticality of a battery module is more severe, as typical BEV does not suffer catastrophic failures if power supply is limited, while an EVTOL aircraft will not be able to land if power is not available due to a failure. Hence, the present invention is very advantageously applicable to EVTOL aircraft.

Preferred embodiments of the present invention will now be described in more detail with respect to the drawings, in which:

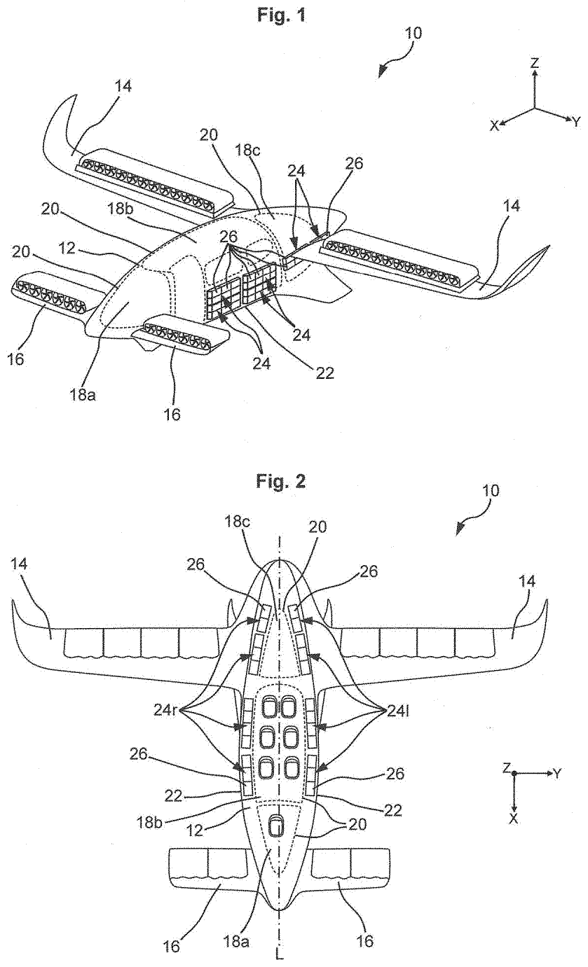

FIG. 1 shows a perspective view of an aircraft according to the preferred embodiments of the present invention,

FIG. 2 shows a top view of the aircraft of FIG. 1,

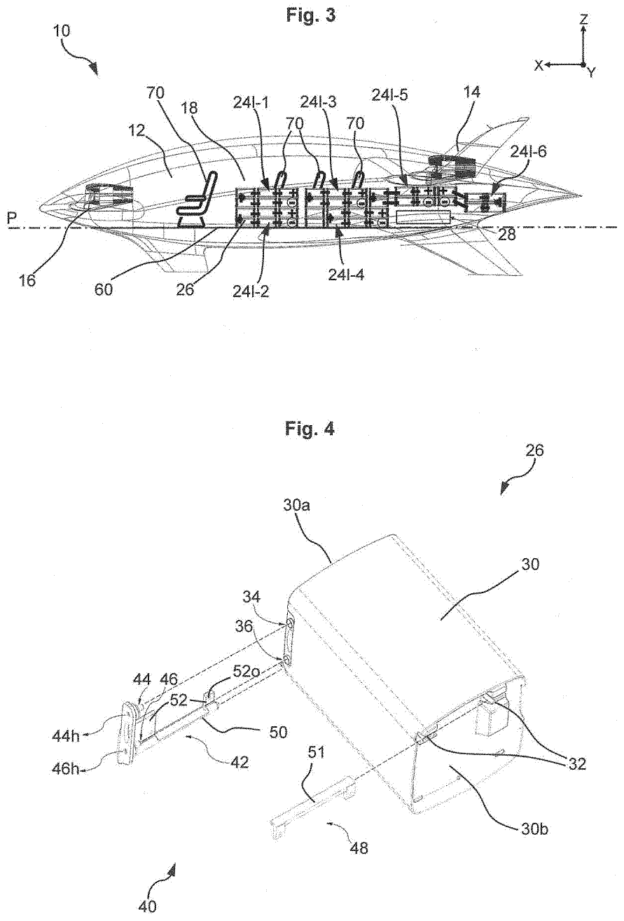

FIG. 3 shows a side view of the aircraft of FIG. 1,

FIG. 4 shows a perspective view of a battery module of a battery system comprised by the aircraft according to a first embodiment of the present invention,

FIG. 5 shows a perspective view of a rack mounting mechanism comprised by a fuselage of the aircraft according to a second embodiment of the present invention,

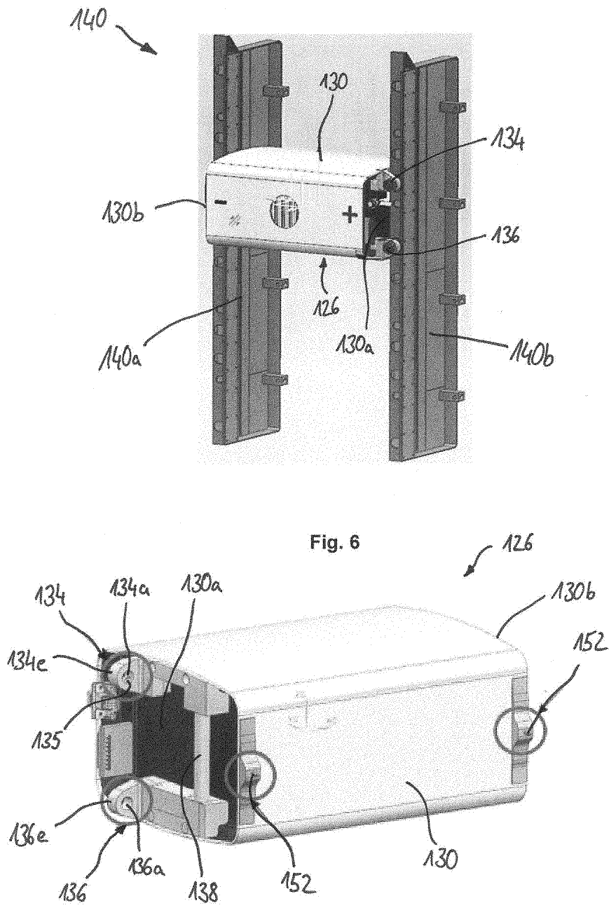

FIG. 6 shows a perspective view of a battery module of a battery system comprised by the aircraft according to the second embodiment of the present invention,

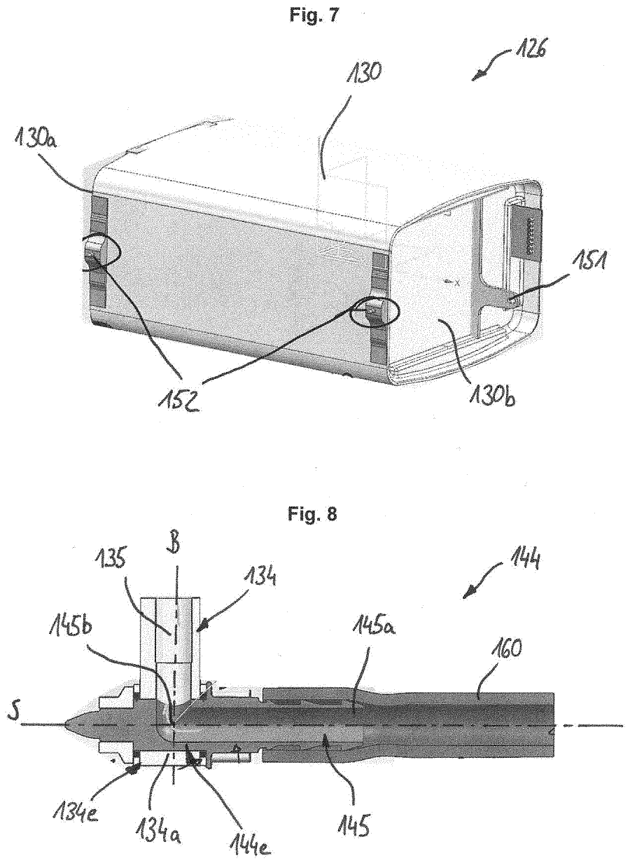

FIG. 7 shows a further perspective view of the battery module of FIG. 7, and

FIG. 8 shows a cross sectional view of a hollow stud of a thermal management system of the battery system according to the second embodiment of the present invention.

In FIG. 1, the aircraft according to the first embodiment of the present invention is generally referred to with reference numeral 10 and comprises a fuselage 12 as well as a first pair of wings 14 and a second pair of wings 16. A plurality of engines may be attached to the wings. The aircraft 10 may further include other components known as such in conventional aircrafts, such as an elevator or landing gears (not shown), for example. An outer fairing wall 22 encloses the fuselage 12 and an interior space 18 is formed inside the fuselage 12 for accommodating at least one person, for example a pilot and/or one or several passengers. In particular, the interior space 18 may be divided into a cockpit 18a, a passenger compartment 18b and a luggage compartment 18c. An inner structural wall 20 in turn encloses the interior space 18.

A longitudinal direction of the fuselage 12 defines a heading direction X of the aircraft 10. A span direction or Y direction is oriented orthogonal to the heading direction X and parallel to a wing plane. The vertical axis, which, in case of a VTOL aircraft, is a set direction, is defined orthogonal to the X direction and the Y direction, i.e. orthogonally to the wing plane. The wing plane or XY plane is the drawing plane in FIG. 2. The XZ plane is the drawing plane in FIG. 3.

The aircraft 10 further comprises a battery system for providing power to electrical systems of the aircraft 10. According to the preferred embodiment of the present invention, the aircraft 10 is a vertical take-off and landing aircraft such that the battery system may be configured to provide electrical power for propulsion of the aircraft 10.

The battery system comprises at least one battery pack 24 and each battery pack 24 comprises a number of individual battery modules 26, which are in particular connected in series (see e.g. FIG. 3).

As better seen in FIG. 2, the battery system comprises a plurality of battery packs 24. In the present invention, battery packs 24 are in particular virtual battery packs 24, which means that a pack only exists by electrically connecting several battery modules 26. Such virtual battery pack 24 does not comprise any housing or pack structure enclosing the single modules 26. The single battery modules 26 in turn are mounted to the aircraft 10 as described later with reference to FIG. 4.

Said plurality of battery packs 24 may be divided into two groups of battery packs 241, 24r. With respect to a longitudinal axis L of the aircraft 10, parallel to the X direction, on either side of the fuselage 12, one of the two groups of battery packs 241, 24r is disposed between the inner structural wall 20 of the fuselage 12 and the outer fairing wall 22 of the fuselage 12.

In the preferred embodiment of the present invention, each group 241, 24r comprises six battery packs 24. First to fourth battery packs 24 are disposed beside the passenger compartment 18b and fifth and sixth battery packs 24 are disposed beside the luggage compartment 18c and preferably below a pair of wings 14 (see FIG. 1 or FIG. 3) in order to ensure easy access from outside for maintenance. In the preferred embodiment of the present invention, the groups 241, 24r of battery packs 24 are arranged on either side of the fuselage 12 substantially symmetrical with respect to longitudinal axis L. In the illustrated example, the first packs are disposed above the second packs in the Z direction. The first and second packs are disposed forward in the heading or X direction. The third packs are disposed above the fourth packs in the Z direction and the third and fourth packs are disposed further back in the X direction. Adjacent thereto, the fifth and sixth packs are disposed side by side in the X direction, with the sixth packs at a backward position in the X direction. In this example, each virtual battery pack 24 may comprise six battery modules 26 arranged in a 2×3 array.

FIG. 3 is a side view of the aircraft 10, in particular showing arrangement and electrical connection of battery packs 24 and modules 26 of the one (in heading direction left) group 241 of battery packs. As mentioned above, the other (right) group 24r may in particular be symmetrical to group 241 with respect to the longitudinal axis L, with the exception that the battery modules 26 may be mounted upside down such that identical modules can be used having terminals facing outside such that maintenance and/or replacement is easier. In FIG. 3, positive pole pack connectors are indicated by a plus sign, and negative pole pack connectors are indicated by an encircled minus sign. Locations of pyro-fuse and battery management master are indicated by the pyro-fuse symbol. As can be seen, decentralized power distribution units 28 are arranged below the wings 14 and the backward battery packs 24l in Z direction and beside the luggage compartment 18c in Y direction.

The fuselage 12 is enclosed by the outer fairing wall 22 and the interior space 18 is formed within the fuselage 12. At a bottom portion of the interior space 18, a bottom plate 60 may be disposed, which defines a bottom plane P extending substantially parallel to the wing plane XY of the aircraft 10 and limits the interior space 18 downwards in Z direction. A plurality of aircrafts seats 70, for example, one or two pilot's seats 70 in the cockpit 18a, and a number of passenger seats 70 in the passenger compartment 18b, may be mounted at the bottom plate 60 of the interior space 18. At side an upper portions of the interior space 18, the inner structural wall 20 limits the interior space 18 of the fuselage 12 laterally in Y direction and upwards in Z direction.

As can be seen in FIG. 3, the at least one battery pack 24 is at least partially, in the preferred embodiment completely, disposed at a height above the bottom plate 60 in Z direction orthogonal to the bottom plane P enabling easier maintenance of the battery system of the aircraft 10, for example in terms of exchangeability of the battery packs 24.

FIG. 4 illustrates one of the battery modules 26 according to the first embodiment of the present invention. The battery module 26 comprises a housing formed from a tube-like enclosure 30, a front end plate 30a and a back end plate 30b, the two end plates closing a front opening and a back opening of the enclosure 30. In the housing, a cell stack may be accommodated.

For cooling and/or heating, an internal channel system can be provided in the battery module 26 within the housing 30. The internal channel system may be connected at both ends to a fluid connector arrangement for connecting the battery module 26 to an external thermal management system. Two fluid lines are embedded into the front plate 30a for connecting the internal channel system to a fluid inlet connector 34 and a fluid outlet connector 36 of the fluid connector arrangement.

As also shown in FIG. 4, in order to position and fix the battery module 26 on the aircraft 10, a guide rail (not shown) for a cylindrical mounting pin 50 of an mounting bracket 42 of the aircraft 10 can be provided the front end plate 30a, e.g. in a lower part thereof, and a similar guide rail 32 for a mounting plate 51 of a further mounting bracket 48 can be provided in the back end plate 30b, e.g. in an upper part thereof.

The mounting brackets 42, 48 can comprise fastening plates 52 with holes 52o through which suitable fasteners can be passed in order to fix each mounting bracket 42, 48 to a corresponding mounting structure (not shown) provided on the aircraft fuselage. In order to fix the mounting plate 51 to the back end plate 30b, for example a simple R-pin (not shown) can be inserted through a hole 199 provided in a distal end portion of mounting plate 51 inserted in and protruding beyond the guide rail 32.

The mounting bracket 42 furthermore comprises self-sealing and preferably dripless push-to connect counter-connectors 44, 46 adapted to be coupled with the fluid connectors 34, 36 provided on the battery module 26. Inlets and outlets 44h, 46h lead to the thermal management system of the aircraft 10.

The guide rails and the push-to connect fluid connectors 34, 36 are oriented in parallel to each other so that the battery module 26 can be attached to the aircraft and connected to the thermal management system at the same time by sliding the battery module 26 onto the corresponding mounting brackets along that direction.

As the cylindrical mounting pin 50 is very precise, the connection between the fluid connectors 34, 36 and the corresponding counter-connectors 44, 46 can be correctly performed. Then, all tolerance stack up is compensated by the play between mounting plate 51 and the corresponding guide rail 32 on the back side of the battery module 26. Additionally, the counter-connectors 44, 46 provided on the mounting bracket 42 can have floating capabilities to compensate for tolerances.

Furthermore, the rotational degree of freedom between the cylindrical mounting pin 50 and the corresponding guide rail provided in the front end plate 30a and the play between mounting plate 51 and guide rail 32 serve to isolate the module from the bending modes of the fuselage when subjected to flight loads, in this case, bending and shear deformation of the fuselage structure.

FIGS. 5 to 8 illustrate a rack mounting mechanism 140 and a battery module 126 according to a further embodiment of the invention or at least parts thereof.

In the following, the further (second) embodiment will primarily be described in more detail only in as far as it is different from the first embodiment. Otherwise, reference is made to the description of the first embodiment as provided above. In addition, it is to be noted that, in FIGS. 1 to 3, the battery module 126 according to the second embodiment may displace the battery module according to the first embodiment and denoted with reference sign 26.

FIG. 5 illustrates the rack mounting mechanism 140 comprised by the fuselage 12 of the aircraft 10 according to the second embodiment of the present invention. The rack mounting mechanism 140 preferably comprises two opposing mounting frames 140a, 140b having mounting rails and a plurality of mounting brackets for receiving a plurality of battery modules 126. Exemplarily, one of the battery modules 126 is illustrated in a state mounted to the mounting frames 140a, 140b.

FIG. 6 illustrates one of the battery modules 126 according to the second embodiment of the present invention. The battery module 126 also comprises a housing formed from a tube-like enclosure 130, a front end plate 130a and a back end plate 130b, the two end plates closing a front opening and a back opening of the enclosure 130. In the housing, in turn a cell stack may be accommodated.

For cooling and/or heating, an internal channel system may be provided in the battery module 126 within the housing 130. The internal channel system may be connected to an external thermal management system of the battery system. Such connection may be realized by a first hollow bolt 134 and a second hollow bolt 136, which may be arranged at the front end plate 130a of the battery module 126. The first hollow bolt 134 may comprise an internal channel 135 functioning as an inlet to the internal channel system of the battery module 126 and the second hollow bolt 136 may comprise an internal channel functioning as an outlet from the internal channel system of the battery module 126. Hence, the thermal management system may supply the internal channel system of the battery module 126 with the heat transfer fluid via the internal channel 135 of the first hollow bolt 134, while the heat transfer fluid may be discharged via the internal channel of the second hollow bolt 136 or vice versa.

In particular, the heat transfer fluid may be passed form the thermal management system through the internal channel of the first hollow bolt into internal channels of an upper cooling plate (not shown) arranged in an upper portion of the battery module 126, subsequently through a bypass line 138 into internal channels of a lower cooling plate (not shown) arranged in a lower portion of the battery module 126, and then through the internal channel of the second hollow bolt out of the battery module 126 and back to the thermal management system.

As can be seen in FIG. 7, battery module 126 according to the second embodiment of the present invention may further comprise a slider portion 151 preferably in the form of a slider tab 151 protruding from the back end plate 130b of the battery module 126 housing 130. Tab 151 may slidably engage a complementary slider seating provided at one of the mounting frames 140a of the rack mounting mechanism 140 to allow a sliding motion of the battery module 126 along a direction of extension of the mounting frame 140a.

Furthermore, the battery module 126 may further comprise at least one blind connector 152, in the embodiment described herein two blind connectors 152, disposed a back side of the battery module 126 housing 130 and configured to fix in place the battery module 126 at the rack mounting mechanism 140. The blind connectors 152 may preferably be realized in the form of small pins or protrusions 152 configured to engage complementary recesses at the side of to the fuselage, in particular provided at one or both of the mounting frames 140a, 140b or at another element of the rack mounting mechanism 140.

With reference to FIG. 8, the connection between the thermal management system and the battery module 126, in particular the hollow bolts 134, 136 provided at the battery module 126, will be explained. FIG. 8 shows a cross sectional view of a hollow stud 144 to be connected with hollow bolt 134. The heat transfer fluid is supplied through a hose 160 coming from the thermal management system into an internal channel 145 of the hollow stud 144.

The internal channel 145 may comprise a first channel portion 145a adjacent to the hose 160 and substantially extending in a direction of extension S of the hollow stud 144. Adjacent to the first channel portion 145a, a second channel portion 145b may be provided, which extends towards the battery module 126 in a direction of extension B of the hollow bolt 134. In particular, the direction of extension B of the hollow stud bolt, and therewith of the second channel portion 145b, may be inclined at approximately 90° with respect to the direction of extension S of the hollow stud 144.

Hence, a rotation of the heat transfer fluid towards the battery module 126 already can take place in the hollow stud 144, in particular at a transition between the first channel portion 145a and the second channel portion 145b of the internal channel 145. Thus, the inclination of the internal channel 145 of the stud 144 allows the stud hole to align with the hole of the bolt 134 of the battery module 126.

Alternatively, instead of the internal channel 145 of the hollow stud 144, the internal channel 135 of the hollow bolt 134, 136 may comprise two channel portion with different directions of extensions, which in particular may be inclined with respect to each other in order to deflect or rotate the fluid within the internal channel 135 of the hollow bolt 134, 136. However, a rotation of the fluid already within the hollow stud 144 is preferred.

Back to FIG. 6, the first and second hollow bolts 134, 136 of battery module 126 may each comprise an annular connector portion 134a, 136a at end portions 134e, 136e thereof protruding from the battery module 126. These annular connector portions 134a, 136a may be configured to receive respective end portions 144e of the first and second hollow studs 144. It is to be noted that only the first hollow stud 144 is illustrated, however, the structure of the second hollow stud may be the same as that of the first hollow stud 144.

In this manner, the hollow studs 144 supplying the heat transfer fluid from the thermal management system may be connected to the battery module 126, in particular to the annular connector portions 134a, 136a of the hollow bolts 134, 136, and moreover the internal channel 145, in particular the inclined second channel portion 145b, of the first hollow stud 144 may be connected to the internal channel 135 of the first hollow bolt 134 and the internal channel of the second hollow stud may be connected to the internal channel 135 of the second hollow bolt 136.

Hence, the connections between the thermal management system and the battery modules 126 used according to the second embodiment of the present invention, first, serve as a mechanical fixation of the battery modules 126 to the fuselage 12, and second, during cooling serve as inlet and outlet for the heat transfer fluid.

1. An aircraft, comprising a fuselage, at least one pair of wings and a battery system for providing power to electrical systems of the aircraft, wherein
the battery system comprises at least one battery pack,
each battery pack comprises a number of individual battery modules, which are directly or indirectly coupled to one another, and
the at least one battery pack is disposed between an inner structural wall defining an interior space of the fuselage and an outer fairing wall of the fuselage.

2. The aircraft according to claim 1, wherein
the fuselage comprises the outer fairing wall enclosing the fuselage and the interior space formed within the fuselage, wherein the interior space is defined by:
at a bottom portion thereof, a bottom plate at which a plurality of aircraft seats are mounted, the bottom plate limiting the interior space of the fuselage downwards and defining a bottom plane (P) substantially parallel to a wing plane (XY) of the aircraft, and
at side and upper portions thereof, the inner structural wall limiting the interior space of the fuselage laterally and upwards, and wherein
the at least one battery pack, in a direction (Z) orthogonal to the bottom plane (P), is at least partially disposed at a height above the bottom plate.

3. The aircraft according to claim 1, wherein
the battery system comprises at least two battery packs, and wherein,
with respect to a longitudinal axis (L) of the aircraft, on either side of the fuselage, at least one of the battery packs is disposed between the inner structural wall of the fuselage and the outer fairing wall of the fuselage.

4. The aircraft according to claim 1, wherein
the battery system comprises a plurality of battery packs, said plurality of battery packs being divided into two groups of battery packs, and wherein,
with respect to a longitudinal axis (L) of the aircraft, on either side of the fuselage, one of the two groups of battery packs is disposed between the inner structural wall of the fuselage and the outer fairing wall of the fuselage.

5. The aircraft according to claim 1, comprising a fuselage, at least one pair of wings and a battery system for providing power to electrical systems of the aircraft, wherein
the battery system comprises at least one battery pack,
each battery pack comprises a number of individual battery modules, which are directly or indirectly coupled to one another, and
the fuselage is provided with a rack mounting mechanism comprising a number of mounting brackets, each for exchangeably mounting one of the battery modules to the aircraft.

6. The aircraft according to claim 5,
wherein the battery system further comprises a thermal management system circulating a heat transfer fluid through the battery modules,
wherein at least one of the battery modules comprises at least one hollow bolt constituting an inlet to or an outlet from an internal channel system of the corresponding battery module for heat transfer fluid within the corresponding battery module via an internal channel of the hollow bolt,
wherein the thermal management system comprises at least one hollow stud configured to supply or receive the heat transfer fluid to or from the correspond battery module via an internal channel of the hollow stud,
wherein the internal channel of the hollow stud is configured to be connected to the internal channel of the hollow bolt, and
wherein the internal channel of the hollow stud comprises a first channel portion substantially extending in a direction of extension (S) of the hollow stud and a second channel portion adjacent to the first channel portion and extending in a direction (B) different from the direction of extension (S) of the hollow stud in a direction (B) inclined at approximately 90° with respect to the direction of extension (S) of the hollow stud and/or parallel to the direction of extension (B) of the hollow bolt,
and/or
wherein the internal channel of the hollow bolt comprises a first channel portion substantially extending in a direction of extension of the hollow bolt and a second channel portion adjacent to the first channel portion and extending in a direction different from the direction of extension of the hollow bolt in a direction inclined at approximately 90° with respect to the direction of extension of the hollow bolt and/or parallel to the direction of extension of the hollow stud.

7. The aircraft according to claim 6,
wherein at least one of the battery modules comprises first and second hollow bolts, each having an annular connector portion at an end portion facing away from the corresponding battery module, the first hollow bolt constituting an inlet to the internal channel system of the corresponding battery module and the second hollow bolt (136) constituting an outlet from the internal channel system of the corresponding battery module via internal channels of the first and second hollow bolts, respectively,
wherein the thermal management system comprises first and second hollow studs, each hollow stud having an internal channel, which comprises a first channel portion substantially extending in a direction of extension (S) of the hollow stud and a second channel portion adjacent to the first channel portion and extending towards the battery module in a direction (B) different from the direction of extension (S) of the hollow stud in a direction (B) inclined at approximately 90° with respect to the direction of extension (S) of the hollow stud, and
wherein end portions of the first and second hollow studs are configured to be received in the annular connector portions of the first and second hollow bolts, respectively, such as to connect the internal channels of the first and second hollow studs to the internal channels of the first and second hollow bolts, respectively.

8. The aircraft according to claim 5, wherein
the rack mounting mechanism comprises at least one mounting frame (140a, 140b) associated to the fuselage, and
at least one of the battery modules further comprises at least one slider portion slidably engaging at least one complementary slider seating provided at the mounting frame of the rack mounting mechanism, to allow a sliding motion of the battery module along a direction of extension of the mounting frame of the rack mounting mechanism.

9. The aircraft according to claim 5, wherein
the rack mounting mechanism comprises at least one mounting frame (140a, 140b) associated to the fuselage, and
at least one of the battery modules further comprises at least one blind connector configured to fix in place the at least one battery module at the rack mounting mechanism.

10. The aircraft according to claim 5, wherein
the battery system further comprises a thermal management system circulating a heat transfer fluid through the battery modules,
at least several battery modules, comprise a fluid inlet connector and a fluid outlet connector connected to an internal channel system of the corresponding battery module for heat transfer fluid within the corresponding battery module and adapted to being connected to the thermal management system, and
at least several mounting brackets comprise counterpart connectors for the fluid inlet and outlet of the corresponding battery module, respectively.

11. The aircraft according to claim 1, comprising a fuselage, at least one pair of wings and a battery system for providing power to electrical systems of the aircraft, wherein:
the battery system comprises at least one battery pack,
each of the battery packs comprises a number of individual battery modules, which are directly or indirectly coupled to one another, and
each of the battery packs is a virtual battery pack, which is obtained by electrically connecting a predetermined number of the battery modules.

12. The aircraft according to claim 1, wherein
the battery modules of each of the battery packs are electrically connected in series by bus bars facing towards an outside of the aircraft.

13. The aircraft according to claim 1, wherein
each of the battery modules is individually secured to the fuselage of the aircraft at a certain mounting position.

14. The aircraft according to claim 13, wherein
the fuselage is provided with a number of said mounting positions, each for interchangeably holding one of the battery modules, the number of mounting positions being larger than the number of battery modules such that, in a mounted state of all battery modules, at least one of the mounting positions remains vacant.

15. The aircraft according to claim 1, wherein
the aircraft is of the electrical propulsion type.

16. The aircraft according to claim 1, wherein
the aircraft is an electric vertical take-off and landing aircraft.
